(19) United States
(12) Patent Application Publication
(10) Pub. No.: US 2024/0340368 A1
(43) Pub. Date: Oct. 10, 2024

(54) Smart Eyewear Device

(71) Applicant: Ravi Persaud, Glenville, NY (US)

(72) Inventor: Ravi Persaud, Glenville, NY (US)

(21) Appl. No.: 18/619,858

(22) Filed: Mar. 28, 2024

Related U.S. Application Data
(60) Provisional application No. 63/494,041, filed on Apr. 4, 2023.

(51) Int. Cl. H04M 1/72409; H04M 1/72466

(52) U.S. Cl. CPC H04M 1/724097; H04M 1/72466; H04M 2201/40

(57) ABSTRACT

A smart eyewear device is disclosed that can change any pair of eyeglasses into Bluetooth smart glasses. The smart eyewear device comprises an arm component for a standard pair of eyeglasses. The arm component comprises Bluetooth technology built inside the frame, which enables wireless communications when listening to music, talking on the phone, etc. Thus, users can listen to music and talk on the phone while remaining fully aware of their surroundings. The arm component can be integrated into eyeglasses, sunglasses, prescription eyeglasses, safety glasses, etc. Further, the smart eyewear device is available in diverse colors, styles, and sizes.

### CROSS-REFERENCE TO RELATED APPLICATION

The present application claims priority to, and the benefit of, U.S. Provisional Application No. 63/494,041, which was filed on Apr. 4, 2023, and is incorporated herein by reference in its entirety.

### FIELD OF THE INVENTION

The present invention relates generally to the field of smart eyewear devices. More specifically, the present invention relates to a pair of eyeglass arms capable of transforming any type of eyewear into smart glasses. Accordingly, the present disclosure makes specific reference thereto the present invention. Nonetheless, it is to be appreciated that aspects of the present invention are also equally applicable to other like applications, devices and methods of manufacture.

### BACKGROUND

By way of background, this invention relates to improvements in smart eyewear devices. Generally, people who wear headphones while walking and traveling outside may be unable to hear different sound queues from the outside world like cars, trucks, etc. Serious injury could occur if a person is unaware of their surroundings. Further, people who wear safety glasses may not be able to listen to music or wear headphones when working. Additionally, smart glasses may be an option for some people, but those working outdoors may risk damage to their expensive eyewear.

Additionally, holding a cell phone to one's head while driving an automobile can be unsafe because the driver has only one hand available to operate the vehicle. Furthermore, holding a cell phone in general can be difficult or at least a distraction in many other situations, such as while typing on a keyboard, walking down a street or in a mall with one's hands full, while riding a bike, etc. Furthermore, hands-free headsets with microphones and speakers connected by wires or wirelessly to a phone can also be inconvenient. These headsets require users to put them on and remove them each time the cell phone is used, which can be a significant inconvenience. Also, such headsets must be stored somewhere when they are removed and not in use, making it more likely that the user will forget them, break them, or be further inconvenienced by carrying a case for them. Accordingly, there remains a need for a wearable audio communication device for remote use of a cell phone or other electronic device, that permits the user to easily, safely, and quietly communicate using the cell phone while engaged in another activity, without the user having to hold the cell phone in his hand, and without the inconvenience of carrying around an extra headset device, donning the headset to make or receive a call, and removing and storing the headset afterward.

Accordingly, there is a demand for an improved smart eyewear device that provides eyeglass arms which comprise smart technology features to enable wireless communications. More particularly, there is a demand for a smart eyewear device that enables users to listen to music and talk on the phone while remaining fully aware of their surroundings.

Therefore, there exists a long felt need in the art for a smart eyewear device that provides users with a pair of eyeglass arms capable of transforming any type of eyewear into smart glasses. There is also a long felt need in the art for a smart eyewear device that includes multiple smart technology features within the eyeglass arms, like Bluetooth connections to enable wireless communications when listening to music, talking on the phone, etc. Further, there is a long felt need in the art for a smart eyewear device that features numerous sizes and styles of eyeglass arms that can be equipped on prescription eyeglasses, sunglasses, safety glasses, etc. Moreover, there is a long felt need in the art for a device that enables users to listen to music and talk on the phone while remaining fully aware of their surroundings. Further, there is a long felt need in the art for a smart eyewear device that comprises eyeglass arms with Bluetooth technology built inside the frames. Finally, there is a long felt need in the art for a smart eyewear device that is available in diverse colors and sizes.

The subject matter disclosed and claimed herein, in one embodiment thereof, comprises a smart eyewear device. The device changes any pair of eyeglasses into Bluetooth smart glasses. The smart eyewear device comprises an arm component for a standard pair of eyeglasses. The arm component comprises Bluetooth technology built inside the frame, which enables wireless communications when listening to music, talking on the phone, etc. Thus, users can listen to music and talk on the phone while remaining fully aware of their surroundings. The arm component can be integrated into eyeglasses, sunglasses, prescription eyeglasses, safety glasses, etc. Further, the smart eyewear device is available in diverse colors, styles, and sizes.

In this manner, the smart eyewear device of the present invention accomplishes all of the forgoing objectives and provides users with a device that provides smart technology features within the arms of an eyeglass. The device can change any pair of eyeglasses into smart glasses. The device can be manufactured of a plastic material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart eyewear device. The device changes any pair of eyeglasses into Bluetooth smart glasses. The smart eyewear device comprises an arm component for a standard pair of eyeglasses. The arm component comprises Bluetooth technology built inside the frame, which enables wireless communications when listening to music, talking on the phone, etc. Thus, users can listen to music and talk on the phone while remaining fully aware of their surroundings. The arm component can be integrated into eyeglasses, sunglasses, prescription eyeglasses, safety glasses, etc. Further, the smart eyewear device is available in diverse colors, styles, and sizes.

In one embodiment, the smart eyewear device comprises an eyeglass which includes a lens frame, with at least one arm component. The lens frame holds lenses preferably made of spherical polycarbonate with impact resistance and 400 nm UV protection. Preferably, the lens frame is Rx compatible for prescription lenses. Typically, the eyeglasses have two arm components each equipped with Bluetooth technology, respective button controls, and a speaker.

Eyeglasses include but are not limited to, glasses (prescription eyeglasses, readers, or spectacles), protective goggles, sunglasses, face shields and masks, etc.

Eyeglasses, also called glasses or spectacles, are frames bearing lenses worn in front of the eyes, normally for vision correction, eye protection, or for protection from UV rays. Modern glasses are typically supported by pads on the bridge of the nose and by arm components placed over the cars.

Eyeglass frames, including the arm components, are commonly made from metal or plastic. Lenses were originally made from glass, but many are now made from various types of plastic, including CR-39 and polycarbonate. These materials reduce the danger of breakage and weigh less than glass lenses. Some plastics also have more advantageous optical properties than glass, such as better transmission of visible light and greater absorption of ultraviolet light. Some plastics have a greater index of refraction than most types of glass; this is useful in the making of corrective lenses shaped to correct various vision abnormalities such as myopia, allowing thinner lenses for a given prescription. Newer plastic lenses, called izon, can also correct for the higher order abberations that naturally occur in the surface of our eye. These lenses create sharper vision and help with the halos, starbursts, and comet-tails often associated with nighttime driving glare.

Scratch-resistant coatings can be applied to most plastic lenses giving them similar scratch resistance to glass. Hydrophobic coatings designed to case cleaning are also available, as are anti-reflective coatings intended to improve night vision and make the user's eyes more visible.

Not all glasses are designed solely for vision correction but are worn for protection, viewing visual information, or simply just for aesthetic or fashion values. Safety glasses are a kind of eye protection against flying debris or against visible and near visible light or radiation. Sunglasses allow better vision in bright daylight and may protect against damage from high levels of ultraviolet light.

Bluetooth connectivity involves connection with a wireless protocol utilizing short-range communications technology facilitating data transmission over short distances from fixed and/or mobile devices, creating wireless personal area networks (PANs). The intent behind the development of Bluetooth was the creation of a single digital wireless protocol, capable of connecting multiple devices and overcoming issues arising from synchronization of these devices.

Bluetooth provides a way to connect and exchange information between devices such as mobile phones, telephones, laptops, personal computers, printers, GPS receivers, digital cameras, and video game consoles over a secure, globally unlicensed Industrial, Scientific, and Medical (SM) 2.4 GHz short-range radio frequency bandwidth.

The wireless Bluetooth connectivity in accordance with the present invention relies upon transceiver circuitry, switches, batteries, one or two speakers and one or two microphones (although any number of microphones and speakers may be used). The present invention is preferably configured or operates in accord with any or all of the following criteria.

In one embodiment, the smart eyewear device comprises an eyewear frame with at least one arm component which is integrated with communication features for sending and receiving signals wirelessly to and from an electronic device such as a cell phone. The arm components each comprise a microphone, a transmitter, a speaker, a receiver, and a power source, all mounted onto the arm component. The microphone receives sound from the user's mouth (or from the user clapping or otherwise making a sound) and converts the sound into a signal representing the sound, and the transmitter sends the signal to the cell phone. The cell phone receives the signal representing a sound, and sends the signal to a speaker. The speaker then converts the signal to an audible sound to be heard by one or both of the user's cars.

Thus, the user can converse over the cell phone privately, easily, and in a hands-free manner whenever he has on the eyewear device. For example, the eyewear device can have prescription lenses, and for a person that wears his glasses much of the time, the communication features of the eyewear device will be readily available for use much of the time. Thus, the user can simply put on the eyewear device in the morning and take them off at night, as he normally does with his regular glasses, and wear his cell phone on his belt, in his pocket, carry it in a purse or bag, or otherwise carry the cell phone remotely from the eyewear device. In this manner, the user can converse on his cell phone anytime and anywhere, privately, without disturbing bystanders.

Also, when wearing the eyewear device, the user need not don and remove a headset every time he makes or receives a call and need not store and carry the headset in a case or the like. Additionally, because the eyewear device provides for hands-free communication over the cell phone, the user can simultaneously converse on the cell phone while engaging in another activity such as typing on a keyboard, driving, biking, mowing the lawn, cating, etc. Of course, the eyewear device can be alternatively provided as sunglasses or mere fashion glasses (with zero power lenses), to provide the convenience of the readily available communication features described above.

Furthermore, the eyewear device can also be used to communicate with web phones, conventional land line phones, PDA's, laptops, hand held computers, personal computers, household appliances, portable or stationary televisions, portable or stationary radios, compact disc players, tape players, or the like, and/or other electronic devices with capabilities for voice recognition and/or for accessing and playing music or other sounds.

The eyeglass frame comprises a lens holder with lenses, and arm components that extend over and are supported by a user's cars. The eyeglass frame can be provided by conventional eyeglass frames made of metal, plastic, or another material, having any of a variety of shapes, as is well known in the art. The lenses can be provided by prescription lenses, tinted sunglasses lenses, a combination thereof, or zero power lenses, or no lenses can be provided, as may be desired. While the eyeglass is typically provided with two lenses and two arm components, it will be understood that the eyeglasses alternatively can be provided by a monocle.

The microphone is mounted to the eyeglass frame for receiving sounds from the user's mouth to be transmitted to the cell phone. The microphone can be provided by a conventional miniature microphone that is embedded into the frame. Also, the microphone can be oriented toward the user's mouth and can be directional so that it picks up the user's voice when wearing the eyewear device but does not pick up as much ambient sound. Although one microphone is shown mounted to the arm component, alternatively, two or another number of microphones can be provided. Also, a sensitivity control can be provided for adjusting the level of sound that the microphone picks up.

The transmitter is mounted to the eyeglass frame and communicates with the microphone by wire, optic fiber, wirelessly, or otherwise. The transmitter can be of a conventional miniature type that is configured to send signals to the cell phone. For example, the transmitter can be configured with BLUETOOTH or other software for wireless transmission of radio signals or another frequency audio or other signals to the cell phone.

The speaker is mounted to the eyeglass frame for playing sounds to be heard by the user's ear. The speaker can be provided by a conventional miniature speaker that is embedded into the arm component. Also, the speaker can be oriented toward the user's car and can be directional so that it plays sounds toward the user's car but does not play sounds that can be easily heard by bystanders. For example, the speaker can be a conventional miniature bone-type speaker that is mounted on an ear rest of the arm component generally adjacent to the user's car when wearing the eyewear device. Although one speaker is shown mounted to the ear rest, alternatively, two or another number of speakers can be provided for producing stereo, quadraphonic, or other sound. Also, a volume control can be provided for adjusting the level of sound that the speaker plays.

The receiver is mounted to the arm component and communicates with the speaker by wire, optic fiber, wirelessly, or otherwise. The receiver can be of a conventional miniature type that is configured to receive signals from the cell phone. For example, the receiver can be configured with BLUETOOTH or other software for wireless reception of radio signals or another frequency audio or other signals from the cell phone.

The power source is mounted to the arm component and electrically connected by a wire to the transmitter and the receiver. The power source provides the power to operate the transmitter and the receiver. For example, the power source can be provided by one or another number of batteries that screw into a receptacle in the arm component. Alternatively, other portable power sources can be used, such as conventional batteries, photovoltaic cells, combinations thereof, and so forth. Controls can be provided for automatically shutting off the device after a predetermined period of time and automatically turning on the device upon reception of a signal from the cell phone, and a manual on/off switch and/or a low power indicator can be provided.

It will be understood by those skilled in the art that the transmitter, receiver, and power source can be selected to provide low power, short range signals, so as not to interfere with signals to and from other devices in the vicinity of the user. However, these components are also selected to provide signals strong enough for transmission and reception between the eyewear device on the user's head and the cell phone disposed remotely from the eye wear device, such as on the user's belt, pocket, carrying bag or purse, etc. Also, the transmitter and the receiver can have optics for receiving infrared signals, instead of or in addition to radio frequency signals.

Additionally, the transmitter, receiver, and/or battery can be provided as separate components or as a single component with a single antenna, mounted to the arm component at another position selected for ease of manufacturing. Also, the wires connecting the microphone to the transmitter, the receiver to the speaker, and/or the battery to the transmitter and the receiver, can be embedded into or mounted onto the arm component. Furthermore, the microphone, transmitter, receiver, speaker, and/or battery can be provided as a retrofit kit, with each component having clips for mounting onto a conventional eyeglasses frame, with the wires not integral to but instead routable along the frame.

In one embodiment, the arm components are detachable apart from the rest of the eyewear and operable independent of the rest of the eyewear or in conjunction to the eyewear when attached. Thus, the arm components can be attached and detached to various suitable eyewear, as is known in the art.

In one embodiment, the Bluetooth equipment can be installed on both the left and right arm components of the device simultaneously, to realize stereo-sonic sound effects, during use. In another embodiment, the Bluetooth equipment can be installed on only the right or the left arm components, not both, depending on the needs and/or wants of a user.

Both arm components are hinged to the lens frame in a conventional manner, such as via screws, adhesive, hinges, etc. The arm component may also have a USB port, a reset button and a power indicator light. The USB port functions is a conventional manner in the same way that conventional USB ports function. By pressing against the reset button, which is recessed, the manufacturer default settings for the eyeglass device may be restored. The indicator light is also recessed with LED(s), and may flash as a steady red light, a flashing red light, a flashing green light or a flashing amber light.

Preferably, the battery selected to power the eyewear device provides over 70 hours of standby time, up to 7 hours of talk time or 5 hours of music playback time when fully charged. The battery can be charged via through a micro USB connector cable either from a USB port of a computer or from an electrical wall outlet. If the USB port of the computer is to be used, a user just engages a socket end of the USB connector into the USB port and plugs the connector at the opposite plug end into the USB port of the computer. If the electrical wall outlet is to be used, a user plugs the connector at that same opposite end of the micro USB connector cable into a bundled adaptor before plugging the adaptor into the electrical wall outlet. When the battery needs charging, the indicator light will flash red. While the battery charging is ongoing, the indicator light will turn a steady red. The indicator light may turn off when the battery is fully charged.

To turn on the eyewear device, a user presses the power button on the arm component, which causes the indicator light to flash from red to amber to green. To turn the eyewear device off, a user presses and holds down the power button for three seconds. A voice prompt “Goodbye” will be heard and the indicator light should flash from green to amber to red. To mute the microphone, press and hold the volume down button until the voice prompt “Muted” is heard. Repeat the procedure to release from mute when the voice prompt “un-mute” is heard. When communication between the eyewear device and the phone/music device is interrupted, such as when the eyewear device is out of range, the eyewear device will attempt to re-establish the connection. If reestablishing connection is unsuccessful after 10 minutes, the eyewear device will automatically turn off.

In one embodiment, a volume up button and a volume down button may be used on the left arm component to adjust the volume. To increase the speaker volume, press the volume up button repeatedly until the desired volume is achieved. To decrease the speaker volume, press the volume down button repeatedly until the desired volume is achieved. When adjusting the speaker volume while the eyewear device is in phone mode, a single high-pitch tone will be heard when the maximum or minimum volume level is reached.

One might expect that the microphone and/or speakers are difficult to use, due to the level of ambient sounds (extraneous background noise), which might impede the clarity of the microphone and/or speakers. However, noise cancellation software, is sufficient to eliminate any noise interference otherwise arising from ambient sounds when using the microphone and/or speakers.

In each of the embodiments, the eyewear device needs to be paired with a Bluetooth enabled device, such as a phone and/or a music device. Preferably, the device supports the following: Bluetooth advanced audio distribution profile (A2dP) for wireless audio streaming and Bluetooth audio/video remote control profile (AVRCP) for wireless control of music.

In operation, to pair the Bluetooth enabled eyewear device of the present invention with such a Bluetooth enabled device (i.e., phone/music device): turn on the Bluetooth feature of the phone/music device, turn on the eyewear device of the present invention by pressing the power button until the indicator light turns red. Search for Bluetooth devices using the phone/music device and select the device from the list of discovered devices from the phone/music device. Follow onscreen prompts to confirm the selection. When pairing is successful, the indicator light will turn from red to green and the voice prompt “pairing successful” is heard. The eyewear device is ready for use.

In one embodiment, the eyewear device can store pairing information for up to eight different phone/music devices. Once pairing is established, the eyewear device will connect to the last connected device each time it turns on and is within range. For instance, pressing the call button will connect the eyewear device to the smart phone that it was last in connection with. Pressing the Play/pause button will connect the eyewear device to the music device that the eyewear device was last in connection with. To connect to a different device in its memory list of paired devices, the connection from that different device to the eyewear device is initiated first. Two different types of music/phone devices can be wirelessly connected to the eyewear device at the same time (such as a phone and an audio player), but two similar devices (such as two phones) cannot be connected to the eyewear device at the same time.

In one embodiment, the eyewear device has a handsfree profile that includes pressing and holding the call button to reject a call, redial last dialed number, put a call on hold, or answer a second incoming call. The handsfree profile also includes making a short press of the call button and speaking the name or command to dial by voice, making a short press of the call button while the call is connected to transfer the call from the phone to the eyewear device, pressing the call button twice to transfer the call from the eyewear device to the phone, pressing the call button and the volume up button to continue the current call while rejecting the second incoming call, and pressing the call button and the volume down button to end the current call and answer the second incoming call.

In one embodiment, pressing the play/pause button to play music or to pause/resume music, pressing and holding the play/pause button to stop the music, pressing the fast forward/next song button to skip to the next song, press the fast backward/previous song button to play the previous song, press the volume up button to increase the volume, and press the volume down button to decrease the volume. To make or receive a call, the call button is pressed, which results in the music control buttons becoming deactivated during the call. Once the call ends, the music automatically resumes from where it left off.

In one embodiment, The indicator light serves as a status indicator by its display and timing of red, amber and green lights from light emitting diodes (LEDs). Circuitry governs the color sequence displayed by the indicator light in correspondence with the happening of certain events. The LEDs may be used: one is red, another is green and the last is amber (or yellow). For pairing, the indicator light shows a steady red light. When pairing in successful, the indicator light flashes to green. When charging, the indicator light shows a steady red light. When charging is complete, the LED light goes off. When idle because the eyewear device is not connected to any device, the indicator light flashes a red light with a longer delay between flashes than in other modes. When powering up the eyewear device, the indicator light flashes red, then amber, then green. When powering down, the indicator light flashes green, then amber, then red. While wirelessly connected to a phone/music device, the indicator light flashes green three times when 100 to 67% of the battery power life remaining, flashes amber three time when 66% to 34% of the battery power life remaining, flashes green three time when 33% to 0% of the battery power life remaining.

In one embodiment, an audio indicator may be provided to provide voice prompts. The audio prompts may arise to signify the following events: power on, power off, Bluetooth pairing is successful, 10% of battery life remaining, power on but not connected, transfer voice from phone to eyewear device, transfer voice from eyewear device to phone, cancel voice dial, incoming call, identity call ID, incoming call answered, answer call waiting and hold first call, end on-going and outgoing calls, reject incoming call or reject call waiting and sustain active call, redial last dialed number, muted microphone every 10 seconds, un-mute microphone, and language selection of prompts (in native language). The voice prompts for these events may be, respectively, “hello:”, “goodbye”, “pairing successful”, “battery low”, “connected”, “transfer to eyewear device”, “transfer to phone”, “cancel”, “ring tone playing”, “digits said”, “call accepted”, “answer call waiting”, “end call”, “call rejected”, “redial”, “muted”, “un-mute”, etc.

In one embodiment, if desired, the control buttons may be supplemented or replaced by sensors that respond to sliding motion of one's finger along the arm component or to heat generated by the human finger in close proximity to the arm component.

In yet another embodiment, the smart eyewear device comprises a plurality of indicia.

In yet another embodiment, a method of enabling users to listen to music and talk on the phone while remaining fully aware of their surroundings is disclosed. The method includes the steps of providing a smart eyewear device comprising an arm component with Bluetooth technology integrated into the frame. The method also comprises inserting the arm component into a pair of eyeglasses. Further, the method comprises engaging the arm component with a user's cellphone to control the Bluetooth technology. Finally, the method comprises wearing the eyeglasses to listen to music and talk on the phone while remaining fully aware of their surroundings.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the smart eyewear device of the present invention showing the Bluetooth speakers integrated into the arm component in accordance with the disclosed architecture;

FIG. 2 illustrates a perspective view of one embodiment of the smart eyewear device of the present invention showing the programmable buttons on the arm component in accordance with the disclosed architecture;

FIG. 3 illustrates a perspective view of one embodiment of the smart eyewear device of the present invention showing the arm component in accordance with the disclosed architecture;

FIG. 4 illustrates a perspective view of one embodiment of the smart eyewear device of the present invention showing the device worn by a user in accordance with the disclosed architecture;

FIG. 5 illustrates a perspective view of one embodiment of the smart eyewear device of the present invention in use in accordance with the disclosed architecture; and

FIG. 6 illustrates a flowchart showing the method of enabling users to listen to music and talk on the phone while remaining fully aware of their surroundings in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a smart eyewear device that provides users with a pair of eyeglass arms capable of transforming any type of eyewear into smart glasses. There is also a long felt need in the art for a smart eyewear device that includes multiple smart technology features within the eyeglass arms, like Bluetooth connections to enable wireless communications when listening to music, talking on the phone, etc. Further, there is a long felt need in the art for a smart eyewear device that features numerous sizes and styles of eyeglass arms that can be equipped on prescription eyeglasses, sunglasses, safety glasses, etc. Moreover, there is a long felt need in the art for a device that enables users to listen to music and talk on the phone while remaining fully aware of their surroundings. Further, there is a long felt need in the art for a smart eyewear device that comprises eyeglass arms with Bluetooth technology built inside the frames. Finally, there is a long felt need in the art for a smart eyewear device that is available in diverse colors and sizes.

The present invention, in one exemplary embodiment, is a novel smart eyewear device. The device changes any pair of eyeglasses into Bluetooth smart glasses. The smart eyewear device comprises an arm component for a standard pair of eyeglasses. The arm component comprises Bluetooth technology built inside the frame, which enables wireless communications when listening to music, talking on the phone, etc. The arm component can be integrated into eyeglasses, sunglasses, prescription eyeglasses, safety glasses, etc. Further, the smart eyewear device is available in diverse colors, styles, and sizes. The present invention also includes a novel method of enabling users to listen to music and talk on the phone while remaining fully aware of their surroundings. The method includes the steps of providing a smart eyewear device comprising an arm component with Bluetooth technology integrated into the frame. The method also comprises inserting the arm component into a pair of eyeglasses. Further, the method comprises engaging the arm component with a user's cellphone to control the Bluetooth technology. Finally, the method comprises wearing the eyeglasses to listen to music and talk on the phone while remaining fully aware of their surroundings.

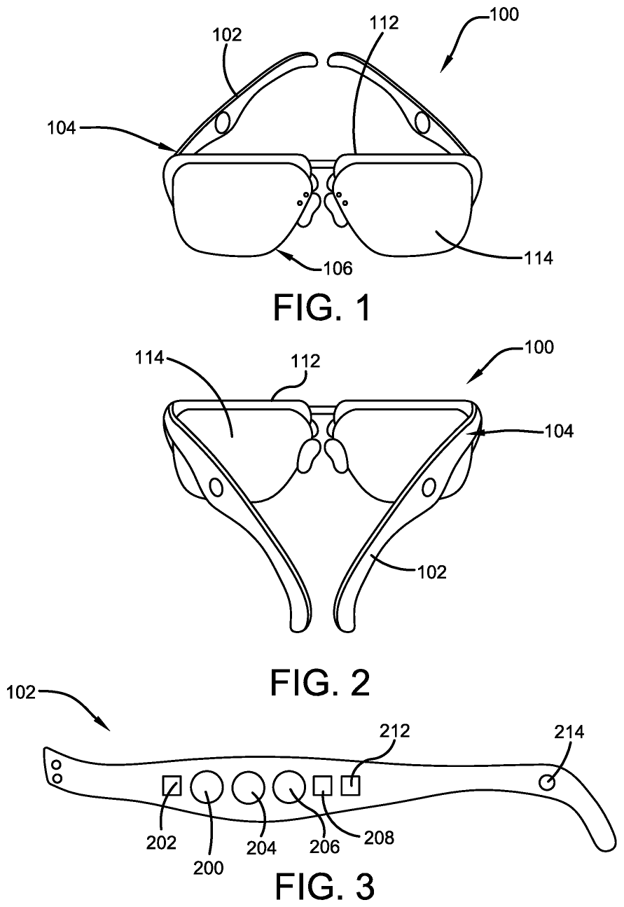

Referring initially to the drawings, FIG. 1 illustrates a perspective view of one embodiment of the smart eyewear device 100 of the present invention. In the present embodiment, the smart eyewear device 100 is an improved smart eyewear device 100 that provides a user 108 with a pair of eyeglass arm components 102 capable of transforming any type of eyewear 106 into smart glasses. Specifically, the smart eyewear device 100 comprises an arm component 102 for a standard pair of eyeglasses 106 with Bluetooth technology 104 integrated in it. The Bluetooth technology 104 enables wireless communications when listening to music, talking on the phone, etc. Thus, users 108 can listen to music and talk on the phone 110 while remaining fully aware of their surroundings. Further, the smart eyewear device 100 is available in diverse colors, styles, and sizes.

Generally, the smart eyewear device 100 comprises an eyeglass/eyewear 106 which includes a lens frame 112, with at least one arm component 102. The lens frame 112 holds lenses 114 preferably made of spherical polycarbonate with impact resistance and 400 nm UV protection. Preferably, the lens frame 112 is Rx compatible for prescription lenses 114. Typically, the eyeglasses 106 have two arm components 102 each equipped with Bluetooth technology 104, respective button controls, and a speaker.

Typically, eyeglasses 106 include but are not limited to, glasses (prescription eyeglasses, readers, or spectacles), protective goggles, sunglasses, face shields and masks, etc. Eyeglasses 106, also called glasses or spectacles, are frames 112 bearing lenses 114 worn in front of the eyes, normally for vision correction, eye protection, or for protection from UV rays. Modern glasses 106 are typically supported by pads on the bridge of the nose and by arm components 102 placed over the cars 116.

Further, eyeglass frames 112, including the arm components 102, are commonly made from metal or plastic. Lenses 114 were originally made from glass, but many are now made from various types of plastic, including CR-39 and polycarbonate. These materials reduce the danger of breakage and weigh less than glass lenses 114. Some plastics also have more advantageous optical properties than glass, such as better transmission of visible light and greater absorption of ultraviolet light. Some plastics have a greater index of refraction than most types of glass; this is useful in the making of corrective lenses 114 shaped to correct various vision abnormalities such as myopia, allowing thinner lenses for a given prescription. Newer plastic lenses, called izon, can also correct for the higher order aberrations that naturally occur in the surface of our eye. These lenses 114 create sharper vision and help with the halos, starbursts, and comet-tails often associated with nighttime driving glare. Additionally, scratch-resistant coatings can be applied to most plastic lenses 114 giving them similar scratch resistance to glass. Hydrophobic coatings designed to case cleaning are also available, as are anti-reflective coatings intended to improve night vision and make the user's eyes more visible.

Furthermore, not all glasses 106 are designed solely for vision correction but are worn for protection, viewing visual information, or simply just for aesthetic or fashion values. Safety glasses are a kind of eye protection against flying debris or against visible and near visible light or radiation. Sunglasses allow better vision in bright daylight and may protect against damage from high levels of ultraviolet light.

Additionally, Bluetooth connectivity/technology 104 involves connection with a wireless protocol utilizing short-range communications technology facilitating data transmission over short distances from fixed and/or mobile devices, creating wireless personal area networks (PANs). The intent behind the development of Bluetooth was the creation of a single digital wireless protocol, capable of connecting multiple devices and overcoming issues arising from synchronization of these devices. Bluetooth provides a way to connect and exchange information between devices 110 such as mobile phones, telephones, laptops, personal computers, printers, GPS receivers, digital cameras, and video game consoles over a secure, globally unlicensed Industrial, Scientific, and Medical (SM) 2.4 GHz short-range radio frequency bandwidth.

Generally, the wireless Bluetooth connectivity/technology 104 in accordance with the present invention relies upon transceiver circuitry, switches, batteries, one or two speakers and one or two microphones (although any number of microphones and speakers may be used). The present invention is preferably configured or operates in accord with any or all of the following criteria.

As shown in FIGS. 2-3, the smart eyewear device 100 comprises an eyewear frame 112 with at least one arm component 102 which is integrated with communication features for sending and receiving signals wirelessly to and from an electronic device such as a cell phone 110. The arm components 102 each comprise a microphone 200, a transmitter 202, a speaker 204, a receiver 206, and a power source 208, all mounted onto the arm component 102. The microphone 200 receives sound from the user's mouth 210 (or from the user 108 clapping or otherwise making a sound) and converts the sound into a signal representing the sound, and the transmitter 202 sends the signal to the cell phone 110. The cell phone 110 receives the signal representing a sound, and sends the signal to a speaker 204. The speaker 204 then converts the signal to an audible sound to be heard by one or both of the user's cars 116.

Thus, the user 108 can converse over the cell phone 110 privately, easily, and in a hands-free manner whenever he has on the eyewear device 100. For example, the eyewear device 100 can have prescription lenses 114, and for a person 108 that wears his glasses 106 much of the time, the communication features of the eyewear device 100 will be readily available for use much of the time. Thus, the user 108 can simply put on the eyewear device 100 in the morning and take them off at night, as he normally does with his regular glasses 106, and wear his cell phone 110 on his belt, in his pocket, carry it in a purse or bag, or otherwise carry the cell phone 110 remotely from the eyewear device 100. In this manner, the user 108 can converse on his cell phone 110 anytime and anywhere, privately, without disturbing bystanders.

Also, when wearing the eyewear device 100, the user 108 need not don and remove a headset every time he makes or receives a call and need not store and carry the headset in a case or the like. Additionally, because the eyewear device 100 provides for hands-free communication over the cell phone 110, the user 108 can simultaneously converse on the cell phone 110 while engaging in another activity such as typing on a keyboard, driving, biking, mowing the lawn, eating, etc. Of course, the eyewear device 100 can be alternatively provided as sunglasses or mere fashion glasses (with zero power lenses), to provide the convenience of the readily available communication features described above.

Furthermore, the eyewear device 100 can also be used to communicate with smart phones 110, web phones, conventional land line phones, PDA's, laptops, hand held computers, personal computers, household appliances, portable or stationary televisions, portable or stationary radios, compact disc players, tape players, or the like, and/or other electronic devices with capabilities for voice recognition and/or for accessing and playing music or other sounds.

Generally, the eyeglass frame 112 comprises a lens holder with lenses 114, and arm components 102 that extend over and are supported by a user's ears 116. The eyeglass frame 112 can be provided by conventional eyeglass frames 112 made of metal, plastic, or another material, having any of a variety of shapes, as is well known in the art. The lenses 114 can be provided by prescription lenses, tinted sunglasses lenses, a combination thereof, or zero power lenses, or no lenses can be provided, as may be desired. While the eyeglass 106 is typically provided with two lenses 114 and two arm components 102, it will be understood that the eyeglasses 106 alternatively can be provided by a monocle.

Generally, the microphone 200 is mounted to the arm component 102 for receiving sounds from the user's mouth 210 to be transmitted to the cell phone 110. The microphone 200 can be provided by a conventional miniature microphone 200 that is embedded into the arm component 102. Also, the microphone 200 can be oriented toward the user's mouth 210 and can be directional so that it picks up the user's voice when wearing the eyewear device 100 but does not pick up as much ambient sound. Although one microphone 200 is shown mounted to the arm component 102, alternatively, two or another number of microphones 200 can be provided. Also, a sensitivity control can be provided for adjusting the level of sound that the microphone 200 picks up.

Further, the transmitter 202 is mounted to the arm component 102 and communicates with the microphone 200 by wire, optic fiber, wirelessly, or otherwise. The transmitter 202 can be of a conventional miniature type that is configured to send signals to the cell phone 110. For example, the transmitter 202 can be configured with BLUETOOTH 104 or other software for wireless transmission of radio signals or another frequency audio or other signals to the cell phone 110.

Additionally, the speaker 204 is mounted to the arm component 102 for playing sounds to be heard by the user's ear 116. The speaker 204 can be provided by a conventional miniature speaker 204 that is embedded into the arm component 102. Also, the speaker 204 can be oriented toward the user's ear 116 and can be directional so that it plays sounds toward the user's ear 116 but does not play sounds that can be easily heard by bystanders. For example, the speaker 204 can be a conventional miniature bone-type speaker that is mounted on an ear rest of the arm component 102 generally adjacent to the user's ear 116 when wearing the eyewear device 100. Although one speaker 204 is shown mounted to the ear rest, alternatively, two or another number of speakers 204 can be provided for producing stereo, quadraphonic, or other sound. Also, a volume control can be provided for adjusting the level of sound that the speaker 204 plays.

Furthermore, the receiver 206 is mounted to the arm component 102 and communicates with the speaker 204 by wire, optic fiber, wirelessly, or otherwise. The receiver 206 can be of a conventional miniature type that is configured to receive signals from the cell phone 110. For example, the receiver 206 can be configured with BLUETOOTH 104 or other software for wireless reception of radio signals or another frequency audio or other signals from the cell phone 110.

Finally, the power source 208 is mounted to the arm component 102 and electrically connected by a wire to the transmitter 202 and the receiver 206. The power source 208 provides the power to operate the transmitter 202 and the receiver 206. For example, the power source 208 can be provided by one or another number of batteries 212 that screw into a receptacle in the arm component 102. Alternatively, other portable power sources 208 can be used, such as conventional batteries 212, photovoltaic cells, combinations thereof, and so forth. Controls can be provided for automatically shutting off the device 100 after a predetermined period of time and automatically turning on the device 100 upon reception of a signal from the cell phone 110, and a manual on/off switch 214 and/or a low power indicator can be provided.

It will be understood by those skilled in the art that the transmitter 202, receiver 206, and power source 208 can be selected to provide low power, short range signals, so as not to interfere with signals to and from other devices 100 in the vicinity of the user 108. However, these components are also selected to provide signals strong enough for transmission and reception between the eyewear device 100 on the user's head and the cell phone 110 disposed remotely from the eyewear device 100, such as on the user's belt, pocket, carrying bag or purse, etc. Also, the transmitter 202 and the receiver 206 can have optics for receiving infrared signals, instead of or in addition to radio frequency signals.

Additionally, the transmitter 202, receiver 206, and/or battery 212 can be provided as separate components or as a single component with a single antenna, mounted to the arm component 102 at another position selected for ease of manufacturing. Also, the wires connecting the microphone 200 to the transmitter 202, the receiver 206 to the speaker 204, and/or the battery 212 to the transmitter 202 and the receiver 206, can be embedded into or mounted onto the arm component 102. Furthermore, the microphone 200, transmitter 202, receiver 206, speaker 204, and/or battery 212 can be provided as a retrofit kit, with each component having clips 216 for mounting onto a conventional eyeglasses frame 112, with the wires not integral to but instead routable along the frame 112.

In one embodiment, the arm components 102 are detachable apart from the rest of the eyewear 106 and operable independent of the rest of the eyewear 106 or in conjunction to the eyewear 106 when attached. Thus, the arm components 102 can be attached and detached to various suitable eyewear 106, as is known in the art, depending on the needs and/or wants of a user 108.

In another embodiment, the Bluetooth equipment 104 can be installed on both the left and right arm components 102 of the device 100 simultaneously, to realize stereo-sonic sound effects, during use. In yet another embodiment, the Bluetooth equipment 104 can be installed on only the right or the left arm components 102, not both, depending on the needs and/or wants of a user 108.

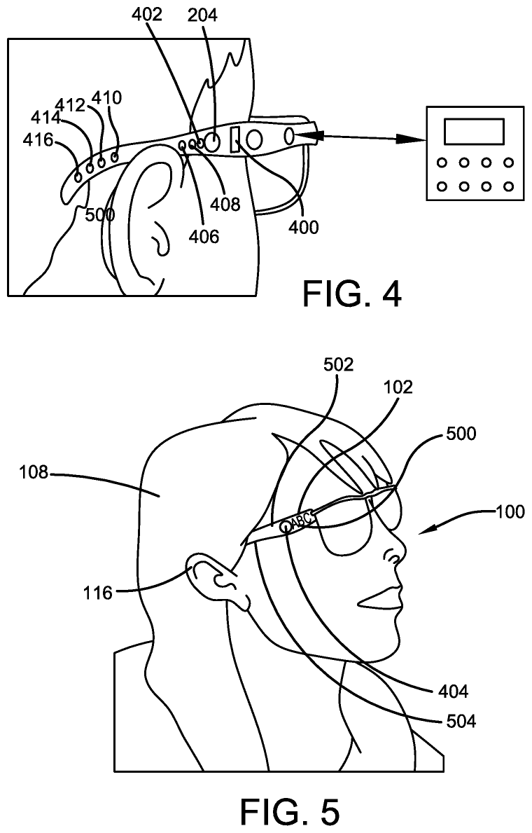

As shown in FIG. 4, both arm components 102 are hinged to the lens frame 112 in a conventional manner, such as via screws, adhesive, hinges, etc. The arm component 102 may also have a USB port 400, a reset button 402 and a power indicator light 404. The USB port 400 functions is a conventional manner in the same way that conventional USB ports 400 function. By pressing against the reset button 402, which is recessed, the manufacturer default settings for the eyeglass device 100 may be restored. The indicator light 404 is also recessed with LED(s), and may flash as a steady red light, a flashing red light, a flashing green light or a flashing amber light.

Preferably, the battery 212 selected to power the eyewear device 100 provides over 70 hours of standby time, up to 7 hours of talk time or 5 hours of music playback time when fully charged. The battery 212 can be charged via through a micro USB connector cable either from a USB port of a computer or from an electrical wall outlet. If the USB port of the computer is to be used, a user 108 just engages a socket end of the USB connector into the USB port 400 and plugs the connector at the opposite plug end into the USB port of the computer. If the electrical wall outlet is to be used, a user 108 plugs the connector at that same opposite end of the micro USB connector cable into a bundled adaptor before plugging the adaptor into the electrical wall outlet. When the battery 212 needs charging, the indicator light 404 will flash red. While the battery 212 charging is ongoing, the indicator light 404 will turn a steady red. The indicator light 404 may turn off when the battery 212 is fully charged.

Preferably, the smart eyewear device 100 is operated in the following manner, but does not have to be, and any additional function buttons can be added or removed as needed. In one embodiment, to turn on the eyewear device 100, a user 108 presses the power button 214 on the arm component 102, which causes the indicator light 404 to flash from red to amber to green. To turn the eyewear device 100 off, a user 108 presses and holds down the power button 214 for three seconds. A voice prompt “Goodbye” will be heard and the indicator light 404 should flash from green to amber to red. To mute the microphone 200, press and hold the volume down button 406 until the voice prompt “Muted” is heard. Repeat the procedure to release from mute when the voice prompt “un-mute” is heard. When communication between the eyewear device 100 and the phone/music device 110 is interrupted, such as when the eyewear device 100 is out of range, the eyewear device 100 will attempt to re-establish the connection. If reestablishing connection is unsuccessful after 10 minutes, the eyewear device 100 will automatically turn off.

In another embodiment, a volume up button 408 and a volume down 406 button may be used on the left arm component 102 to adjust the volume. To increase the speaker volume, press the volume up button 408 repeatedly until the desired volume is achieved. To decrease the speaker volume, press the volume down button 406 repeatedly until the desired volume is achieved. When adjusting the speaker volume while the eyewear device 100 is in phone mode, a single high-pitch tone will be heard when the maximum or minimum volume level is reached.

One might expect that the microphone 200 and/or speakers 204 are difficult to use, due to the level of ambient sounds (extraneous background noise), which might impede the clarity of the microphone 200 and/or speakers 204. However, noise cancellation software, is sufficient to eliminate any noise interference otherwise arising from ambient sounds when using the microphone 200 and/or speakers 204.

In each of the embodiments, the eyewear device 100 needs to be paired with a Bluetooth enabled device, such as a phone 110 and/or a music device. Preferably, the device 110 supports the following: Bluetooth advanced audio distribution profile (A2dP) for wireless audio streaming and Bluetooth audio/video remote control profile (AVRCP) for wireless control of music.

In operation, to pair the Bluetooth enabled eyewear device 100 of the present invention with such a Bluetooth enabled device 110 (i.e., phone/music device): turn on the Bluetooth feature of the phone/music device 110, turn on the eyewear device 100 of the present invention by pressing the power button 214 until the indicator light turns red. Search for Bluetooth devices using the phone/music device 110 and select the device 100 from the list of discovered devices from the phone/music device 110. Follow onscreen prompts to confirm the selection. When pairing is successful, the indicator light 404 will turn from red to green and the voice prompt “pairing successful” is heard. The eyewear device 100 is ready for use.

In one embodiment, the eyewear device 100 can store pairing information for up to eight different phone/music devices 110. Once pairing is established, the eyewear device 100 will connect to the last connected device each time it turns on and is within range. For instance, pressing the call button will connect the eyewear device 100 to the smart phone 110 that it was last in connection with. Pressing the Play/pause button will connect the eyewear device 100 to the music device that the eyewear device 100 was last in connection with. To connect to a different device in its memory list of paired devices, the connection from that different device to the eyewear device 100 is initiated first. Two different types of music/phone devices can be wirelessly connected to the eyewear device 100 at the same time (such as a phone and an audio player), but two similar devices 110 (such as two phones) cannot be connected to the eyewear device 100 at the same time.

In one embodiment, the eyewear device 100 has a handsfree profile that includes pressing and holding the call button 410 to reject a call, redial last dialed number, put a call on hold, or answer a second incoming call. The handsfree profile also includes making a short press of the call button 410 and speaking the name or command to dial by voice, making a short press of the call button 410 while the call is connected to transfer the call from the phone 110 to the eyewear device 100, pressing the call button 410 twice to transfer the call from the eyewear device 100 to the phone 110, pressing the call button 410 and the volume up button 408 to continue the current call while rejecting the second incoming call, and pressing the call button 410 and the volume down button 406 to end the current call and answer the second incoming call.

In one embodiment, pressing the play/pause button 412 to play music or to pause/resume music, pressing and holding the play/pause button 412 to stop the music, pressing the fast forward/next song button 414 to skip to the next song, press the fast backward/previous song button 416 to play the previous song, press the volume up button 408 to increase the volume, and press the volume down button 406 to decrease the volume. To make or receive a call, the call button 410 is pressed, which results in the music control buttons becoming deactivated during the call. Once the call ends, the music automatically resumes from where it left off.

In another embodiment, the indicator light 404 serves as a status indicator by its display and timing of red, amber and green lights from light emitting diodes (LEDs). Circuitry governs the color sequence displayed by the indicator light 404 in correspondence with the happening of certain events. The LEDs may be used: one is red, another is green and the last is amber (or yellow). For pairing, the indicator light 404 shows a steady red light. When pairing in successful, the indicator light 404 flashes to green. When charging, the indicator light 404 shows a steady red light. When charging is complete, the LED light goes off. When idle because the eyewear device 100 is not connected to any device 110, the indicator light 404 flashes a red light with a longer delay between flashes than in other modes. When powering up the eyewear device 100, the indicator light 404 flashes red, then amber, then green. When powering down, the indicator light 404 flashes green, then amber, then red. While wirelessly connected to a phone/music device 110, the indicator light 404 flashes green three times when 100 to 67% of the battery power life remaining, flashes amber three time when 66% to 34% of the battery power life remaining, flashes green three time when 33% to 0% of the battery power life remaining.

As shown in FIG. 5, in one embodiment, an audio indicator 502 may be provided to provide voice prompts. The audio prompts may arise to signify the following events: power on, power off, Bluetooth pairing is successful, 10% of battery life remaining, power on but not connected, transfer voice from phone to eyewear device, transfer voice from eyewear device to phone, cancel voice dial, incoming call, identity call ID, incoming call answered, answer call waiting and hold first call, end on-going and outgoing calls, reject incoming call or reject call waiting and sustain active call, redial last dialed number, muted microphone every 10 seconds, un-mute microphone, and language selection of prompts (in native language). The voice prompts for these events may be, respectively, “hello:”, “goodbye”, “pairing successful”, “battery low”, “connected”, “transfer to eyewear device”, “transfer to phone”, “cancel”, “ring tone playing”, “digits said”, “call accepted”, “answer call waiting”, “end call”, “call rejected”, “redial”, “muted”, “un-mute”, etc.

In another embodiment, if desired, the control buttons may be supplemented or replaced by sensors 504 that respond to sliding motion of one's finger along the arm component 102 or to heat generated by the human finger in close proximity to the arm component 102.

In yet another embodiment, the smart eyewear device 100 comprises a plurality of indicia 500. The arm component 102 of the device 100 may include advertising, a trademark, or other letters, designs, or characters, printed, painted, stamped, or integrated into the arm component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be eyewear, Bluetooth, or brand related.

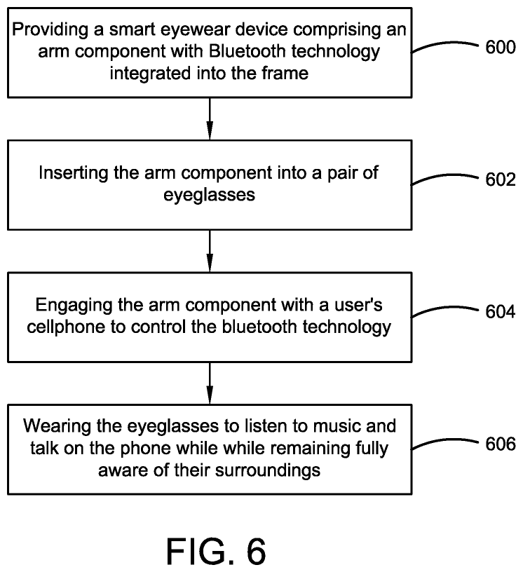

FIG. 6 illustrates a flowchart of the method of enabling users to listen to music and talk on the phone while remaining fully aware of their surroundings. The method includes the steps of at 600, providing a smart eyewear device comprising an arm component with Bluetooth technology integrated into the frame. The method also comprises at 602, inserting the arm component into a pair of eyeglasses. Further, the method comprises at 604, engaging the arm component with a user's cellphone to control the Bluetooth technology. Finally, the method comprises at 606, wearing the eyeglasses to listen to music and talk on the phone while remaining fully aware of their surroundings.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “smart eyewear device”, “eyewear device”, “smart device”, and “device” are interchangeable and refer to the smart eyewear device 100 of the present invention.

Notwithstanding the forgoing, the smart eyewear device 100 of the present invention can be of any suitable size and configuration as is known in the art without affecting the overall concept of the invention, provided that it accomplishes the above stated objectives. One of ordinary skill in the art will appreciate that the smart eyewear device 100 as shown in FIGS. 1-6 is for illustrative purposes only, and that many other sizes and shapes of the smart eyewear device 100 are well within the scope of the present disclosure. Although the dimensions of the smart eyewear device 100 are important design parameters for user convenience, the smart eyewear device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart eyewear device that transforms any type of eyewear into smart glasses, the smart eyewear device comprising:
at least one arm component; and
a Bluetooth technology;
wherein the at least one arm component is secured to a conventional eyeglass frame at a temple of the eyeglass frame to configure a pair of eyeglasses;
wherein the Bluetooth technology enables wireless communications when listening to music or talking on a cell phone while wearing the configured pair of eyeglasses; and
further wherein the at least one arm component is integrated with communication features for sending and receiving signals wirelessly to and from an electronic device such as a cell phone.

2. The smart eyewear device of claim 1, wherein there are two arm components each equipped with Bluetooth technology and secured at a temple of a lens frame, and wherein the lens frame holds lenses for vision correction or eye protection and is configured as a pair of eyeglasses.

3. The smart eyewear device of claim 2, wherein the pair of eyeglasses are prescription eyeglasses, readers, spectacles, protective goggles, sunglasses, face shields or face masks.

4. The smart eyewear device of claim 3, wherein the two arm components each comprise a microphone, a transmitter, a speaker, a receiver, and a power source, all mounted within the two arm components.

5. The smart eyewear device of claim 4, wherein the microphone is mounted to the two arm components for receiving sounds from a user's mouth to be transmitted to a cell phone, the microphone can be oriented toward the user's mouth and can be directional so that it picks up a user's voice when wearing the smart eyewear device but does not pick up as much ambient sound.

6. The smart eyewear device of claim 5, wherein the transmitter is mounted to the two arm components and communicates with the microphone by wire, optic fiber, or wirelessly, the transmitter is configured to send signals to the cell phone.

7. The smart eyewear device of claim 6, wherein the speaker is mounted to the two arm components for playing sounds to be heard by the user's ear, the speaker is oriented toward the user's ear and can be directional so that it plays sounds toward the user's ear but does not play sounds that can be easily heard by bystanders.

8. The smart eyewear device of claim 7, wherein the receiver is mounted to the two arm components and communicates with the speaker by wire, optic fiber, or wirelessly, and is configured to receive signals from the cell phone.

9. The smart eyewear device of claim 8, wherein the power source is mounted to the two arm components and is electrically connected by a wire to the transmitter and the receiver.

10. The smart eyewear device of claim 9, wherein the power source is at least one rechargeable battery.

11. The smart eyewear device of claim 10, wherein instead of integrated into the two arm components, the microphone, transmitter, receiver, speaker, and/or battery can be provided as a retrofit kit, with each component having clips for mounting onto a conventional eyeglasses frame with existing arm components.

12. The smart eyewear device of claim 11, wherein the two arm components are detachable apart from a rest of the smart eyewear device and operable independent of the rest of the smart eyewear device and can be attached to other frames, as needed.

13. The smart eyewear device of claim 12, wherein the Bluetooth technology is installed on both the left and right arm components of the smart eyewear device simultaneously, to realize stereo-sonic sound effects, during use.

14. The smart eyewear device of claim 12, wherein the Bluetooth technology is installed in only the right or the left arm components but not both.

15. A smart eyewear device that transforms any type of eyewear into smart glasses, the smart eyewear device comprising:
two arm components; and
a Bluetooth technology;
wherein the two arm components are each equipped with Bluetooth technology and secured at a temple of a lens frame, and wherein the lens frame holds lenses for vision correction or eye protection and is configured as a pair of eyeglasses;
wherein the Bluetooth technology enables wireless communications when listening to music or talking on a cell phone while wearing the configured pair of eyeglasses;
wherein the two arm components are each integrated with a microphone, a transmitter, a speaker, a receiver, and a power source;
wherein the power source is at least one rechargeable battery;
wherein the two arm components comprise a USB port;
wherein the two arm components comprise a plurality of control buttons, such as a power button, volume controls, a reset button, a call button, a play button, and a music control button; and
wherein the two arm components are detachable apart from the lens frame and operable independent of the rest of the pair of eyeglasses and can be attached to other lens frames, as needed.

16. The smart eyewear device of claim 15, wherein the two arm components comprise an indicator light that serves as a status indicator by its display and timing of red, amber and green lights from light emitting diodes (LEDs).

17. The smart eyewear device of claim 15, wherein the two arm components comprise an audio indicator for providing voice prompts.

18. The smart eyewear device of claim 15, wherein the two arm components comprise sensors instead of control buttons.

19. The smart eyewear device of claim 15 further comprising a plurality of indicia.

20. A method of enabling users to listen to music and talk on the phone while remaining fully aware of their surroundings, the method comprising the following steps:
providing a smart eyewear device comprising an arm component with Bluetooth technology integrated into the frame;
inserting the arm component into a pair of eyeglasses;
engaging the arm component with a user's cellphone to control the Bluetooth technology; and
wearing the eyeglasses to listen to music and talk on the phone while remaining fully aware of their surroundings.
